(19) United States
(12) Patent Application Publication
(10) Pub. No.: US 2006/0136916 A1
(43) Pub. Date: Jun. 22, 2006

(54) Method and apparatus for transaction performance and availability management based on program component monitor plugins and transaction performance monitors

(76) Inventors: John Richards Rowland, Coupland, TX (US); Kirk Malcolm Sexton, Austin, TX (US)

Correspondence Address: IBM CORP (YA);C/O YEE & ASSOCIATES PC, P.O. BOX 802333, DALLAS, TX, 75380, US

(21) Appl. No.: 11/016,223

(22) Filed: Dec. 17, 2004

(51) Int. Cl. G06F 9/46

(52) U.S. Cl. 718/100; 709/203

(57) ABSTRACT

A plug-in program for monitoring an application having a set of threads. A parameter is associated with each thread. The plug-in program causes an individual thread associated with the application to be terminated if a corresponding parameter violates a threshold. The thread is terminated without interfering with the execution of the other threads within the set of threads.

### BACKGROUND OF THE INVENTION

1. Technical Field

The inventions described herein relate to computers and computer programs. In particular, the present invention relates to methods and devices for improving transaction performance and availability management in computers and computer programs.

2. Description of Related Art

Modern computers, particularly servers, can operate in environments where the computers are required to run many programs simultaneously or to handle vast numbers of transactions via a connection over a network, such as the Internet. A problem encountered in these heavy workload environments is that a program or connection that consumes too much of a computer's resources will likely cause other programs or connections to be processed more slowly or less efficiently. For example, if a transaction implemented over the Internet takes too much time, then a server's ability to handle other Internet transactions is reduced. In another example, if a transaction executed within an application takes too much time, then the server's ability to deal with other transactions within the server is reduced. Examples of transactions include, but are not limited to, placing an order over a network, transferring money over a network, delivering a file over a network, executing an operation within a program, executing a program within an application and any other transaction between computers or within a computer. In yet another example, if a program consumes too much of the server's resources, then the server's ability to handle other programs is reduced.

One prior method of dealing with this problem is to monitor how much of a computer's resources a program is using. If the program is consuming more resources than a selected threshold, then the program is terminated. Similarly, if a connection is taking up too much of a server's resources or is moving too slowly, then the connection is terminated.

However, this prior method has the disadvantage of denying a user access to the program or, in the case of connections, of disconnecting a user from the server. As a result, valuable time or data can be lost. Thus, it would be advantageous to have a method, apparatus and computer instructions for preventing a program from consuming too much of a computer's resources, but without terminating the user's ability to use the program.

### SUMMARY OF THE INVENTION

The present invention provides a method, apparatus and computer instructions for monitoring each thread running in conjunction with an application that is running on a computer. A parameter, such as the time a thread has been running, is associated with the thread. A threshold, such as the maximum allowed time for a thread to accomplish a task, is established. If the parameter violates the threshold, then the individual thread is terminated without terminating the entire application.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems.

FIG. 2 is a block diagram of a data processing system that may be implemented as a server, such as server 104 in FIG. 1.

FIG. 3 is a block diagram illustrating a data processing system in which the present invention may be implemented.

FIG. 4 is a block diagram of a monitoring process in which a plug-in program may be implemented in accordance with a preferred embodiment of the present invention.

FIG. 5 is a flowchart of the steps taken by a plug-in program that may be implemented on a server in accordance with a preferred embodiment of the present invention.

FIG. 6 is a flowchart of a procedure for terminating an operation once the decision to terminate a has been made in accordance with a preferred embodiment of the present invention.

### DETAILED DESCRIPTION OF THE PREFERRED EMBODIMENTS

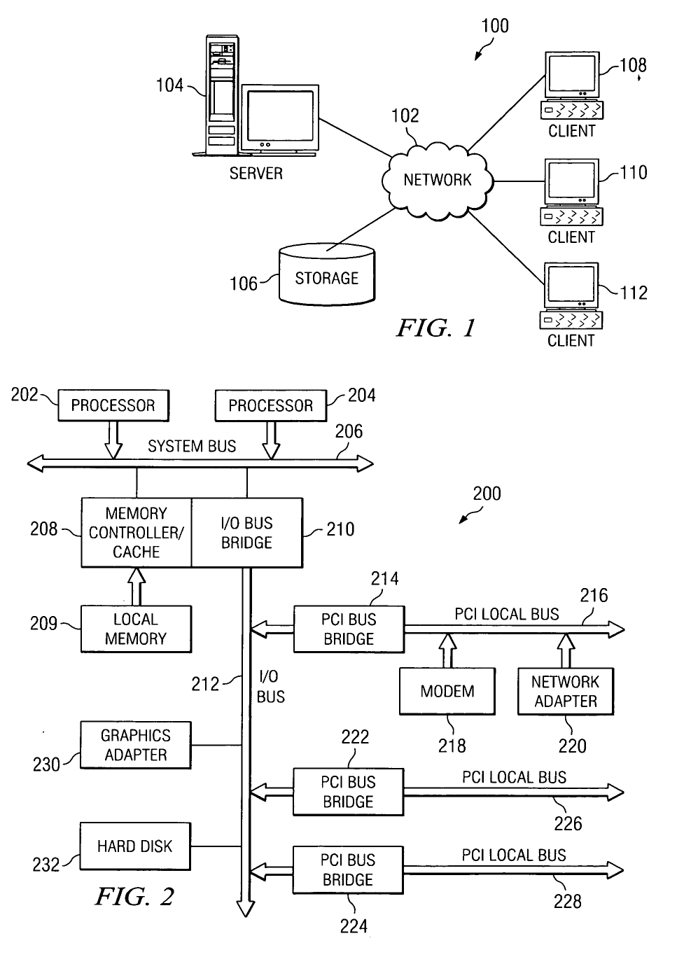

FIG. 1 is a pictorial representation of a network of data processing systems. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, running system images, and programs to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

FIG. 2 is a block diagram of a data processing system that may be implemented as a server, such as server 104 in FIG. 1. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O Bus Bridge 210 is connected to system bus 206 and provides an interface to I/O bus 212. Memory controller/cache 208 and I/O Bus Bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) running system or LINUX running system.

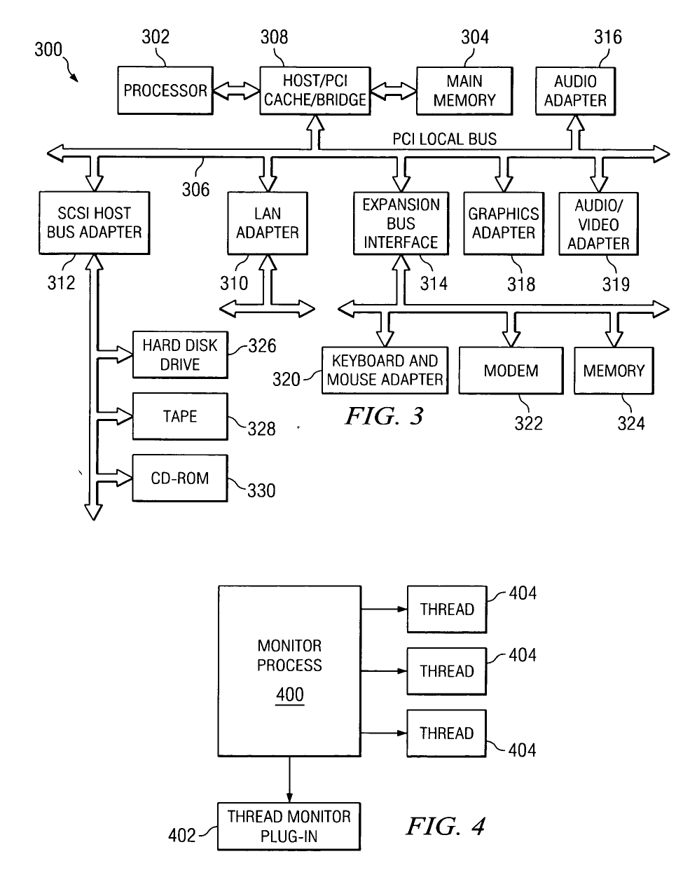

FIG. 3 is a block diagram illustrating a data processing system in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI Bridge 308. PCI Bridge 308 also may include an integrated memory controller and cache memory for processor 302. Additional connections to PCI local bus 306 may be made through direct component interconnection or through add-in boards. In the depicted example, local area network (LAN) adapter 310, small computer system interface (SCSI) host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. SCSI host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The running system may be a commercially available running system, such as Windows XP, which is available from Microsoft Corporation. An object oriented programming system such as Java may run in conjunction with the running system and provide calls to the running system from Java programs or programs executing on data processing system 300. “Java” is a trademark of Sun Microsystems, Inc. Instructions for the running system, the object-oriented programming system, and programs or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces As a further example, data processing system 300 may be a personal digital assistant (PDA) device, which is configured with ROM and/or flash ROM in order to provide non-volatile memory for storing running system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

FIG. 4 is a block diagram of a monitoring process in which a plug-in program, such as plug-in program 402, may be implemented in accordance with a preferred embodiment of the present invention. Plug-in program 402 may operate on a server, such as servers 104 or 200, or a client, such as clients 108, 110, 112 or 300. Plug-in program 402 monitors application 400 and specifically monitors a number of threads 404 associated with application 400. Preferably, application 400 is itself a monitoring application that monitors transactions over a network or that monitors a plurality of additional applications running on a server. Each transaction or additional application may be a thread 404 or each transaction or additional application may themselves comprise a plurality of threads 404. Alternatively, application 400 need not be a monitoring program. In this case, application 400 may have one or more additional applications or network connections associated with application 400 and each additional application or network connection may have a number of threads 404. Plug-in program 402 need not be a plug-in program, but may be part of application 400 itself, depending on the implementation of plug-in program 402.

A parameter is associated with each thread 404. Plug-in program 402 causes an individual thread 404 to be terminated when the parameter violates a threshold. In a preferred embodiment, the thread is terminated without terminating application 400 itself and without preventing execution of any other thread.

Plug-in program 402 may monitor more than one application 400. Thus, plug-in program 402 may monitor a plurality of threads within a plurality of applications. Plug-in program 402 may cause a thread to be terminated within any application without terminating any application.

As indicated above, application 400 may be an application that monitors network traffic, particularly traffic over the Internet. Such a network monitoring application may generate statistical reports on the transactions flowing through a server, such as servers 104 or 200. Plug-in program 402 is a plug-in module that operates in conjunction with the network monitoring application 400. Upon activation of network monitoring application 400, plug-in program 402 is activated and registered locally with network monitoring application 400. Plug-in program 402 uses information collected about threads monitored by network monitoring application 400. In addition, plug-in program 402 may monitor threads spun by the network monitoring application itself.

In any case, plug-in program 402 establishes one or more parameters for each thread 404 and further uses information gathered by the network monitoring program to determine whether a parameter has violated a threshold. If the parameter has violated a threshold, plug-in program 402 causes the corresponding thread to be terminated. However, network monitoring application 400 itself and other threads associated with the network monitoring application remain unaffected. Thus, threads 404 that take too much time or that consume too much of a server's resources are terminated without terminating network monitoring application 400 or any thread monitored by monitoring application 400. If the violating thread is vital to the operation of network monitoring application 400, then the network, monitoring application itself can be terminated when necessary.

In addition, plug-in program 402 may be a stand-alone program designed to operate on an individual computer. In this case, plug-in program 402 monitors one or more additional programs running on the computer and terminates threads 404 within those programs that become non-responsive or that consume too much of the computer's resources. Similarly, plug-in program 402 may be used to alert the user that a parameter associated with a thread 404 has violated a threshold and allow the user to determine the appropriate course of action. In addition, plug-in program 402 may be used to terminate an additional program if too many threads must be terminated or if the additional program becomes unstable or non-responsive.

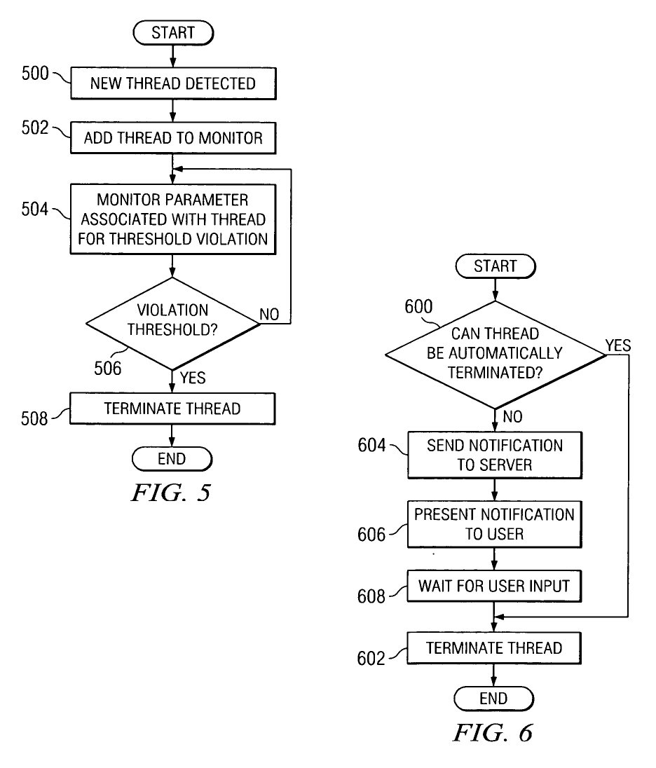

FIG. 5 is a flowchart of the steps taken by a plug-in program, such as plug-in program 402, that may be implemented on a server, such as servers 104 or 200, in accordance with a preferred embodiment of the present invention. Plug-in program 402 may also be implemented on a client, such as clients 108, 110, 112, or 300. The method illustrated in FIG. 5 may be used in conjunction with plug-in program 402 of FIG. 4 or may be a stand-alone program.

The method described in relation to FIG. 5 prevents a program that consumes too much of a computer's resources from degrading the overall performance of a computer. Individual threads within the program that are contributing to the problem are terminated, thereby allowing the computer to use more resources to process other programs. The program itself remains unaffected.

The process begins with monitoring application 400 detecting a set of new threads running within a new program in use on the computer (step 500). Plug-in program 402 uses the information gathered by the monitoring program to register the set of threads 404 with plug-in program 402 (step 502). If monitoring application 400 does not identify operating threads, then plug-in program 402 may be provided with instructions to identify threads running in relation to application 400, or in relation to any other application to be monitored. Plug-in program 402 then registers the running threads with plug-in program 402. Similarly, plug-in program 402 uses information gathered by monitoring application 400 or by plug-in program 402 itself to establish a parameter, such as the time a thread takes to accomplish a task, to be monitored.

Plug-in program 402 then monitors whether the parameter associated with a thread violates a threshold (step 504) established by plug-in program 402. Plug-in program 402 determines whether a parameter has been violated by comparing the value of a parameter to the value of a threshold. If the value of the parameter equals or exceeds the value of the threshold, then the parameter violates the threshold.

In addition, the violation may be detected by a monitoring application 400 or by a separate monitoring program used to monitor parameters associated with the threads. In this case, the violation is reported to plug-in program 402, which either automatically terminates the thread without affecting the other threads or waits for user input to take appropriate action.

In the process of FIG. 5, the parameter is the time the thread requires to complete a task and the threshold is the maximum time a thread is given to accomplish a task. The parameter violates the threshold if the time the thread requires to complete a task equals or exceeds the threshold

Alternatively, the parameter may be how much of the computer's resources the thread uses. The parameter, in this example, is the percentage of resources available to the CPU (or other processor) on the computer used by the thread. In this case, the threshold is a selected percentage of the maximum resources available to the computer. The parameter violates the threshold if the percentage of resources used by the thread equals or exceeds the selected percentage.

Other parameters and thresholds may also be used in the program shown in FIG. 5. The threshold may be pre-selected during programming, selected by a user after installation or may be determined dynamically or automatically during use based on prevailing operating conditions. In the latter case, a threshold may change according to pre-programmed policies or policies entered by a user.

For example, another type of parameter that may be used is the amount of memory utilized by a thread. In this case, additional byte code insertion can be performed to track object instantiation in the context of a thread. The data generated by tracking object instantiation is used to build a memory utilization model of the thread. If the memory utilization model equals or exceeds a maximum predefined threshold model, then plug-in program 402 causes the thread to be terminated.

In addition, multiple parameters may be monitored for each thread. For example, both the time required to complete a thread and the amount of resources the thread uses may be monitored. Similarly, separate thresholds may be established for each type of threshold. Thus, a thread may be allowed to run even if it consumes much of the computer's resources, but not if it takes more than a short time to complete a task.

In addition, types of threads can be classified and sorted into groups. The same parameter for each thread in each group is monitored; however, threads in one group may receive a different threshold than threads in another group. For example, one type of thread may be a connection among a plurality of network connections to a server. Another type of thread may be running in an application. The parameter monitored in both groups is the amount of server resources a thread is consuming. However, in this example, applications are allowed more server resources than network connections. Thus, the threshold for application threads is higher than the threshold for network connection threads. Similarly, different thresholds may be established for different threads within applications and different thresholds may be established for different threads within network connections.

In any case, a determination is made whether one or more parameters associated with an individual thread have violated one or more thresholds (step 506). If not, then monitoring is continued (step 504). If so, then the thread is terminated (step 508).

Instead of terminating the thread, plug-in program 402 may alert a user that one or more parameters associated with an individual thread have violated one or more thresholds. The system then awaits input from the user, who determines the appropriate course of action.

In addition, plug-in program 402 may also be programmed to terminate entire programs or connections if too many threads within the program must be terminated or if the program or connection becomes unstable or non-responsive. Thus, plug-in program 402 can cause an entire set of network connections to terminate or can cause an entire application to terminate.

In use, the method shown in FIG. 5 may be used to monitor a plurality of threads running in a plurality of programs running simultaneously on a computer. The program represented in FIG. 5 ensures that any individual thread is terminated if the thread has a parameter that violates a threshold. Computer resources thereby are preserved so that the computer has more resources available to process other programs or threads or so that other programs or threads may operate at increased efficiency.

For example, if a thread takes too much time to accomplish a task, then the thread is terminated. Similarly, if a thread is consuming too much of the resources of the computer's CPU, then the thread is terminated. Likewise, if a transaction within a connection is taking too long to accomplish a task or is consuming too much of the computer's ability to handle data, then the transaction is terminated without terminating the connection itself.

FIG. 6 is a flowchart of a procedure for terminating an operation once the decision to terminate a thread, step 508, has been made in accordance with a preferred embodiment of the present invention. The procedure shown in FIG. 6 may be implemented in plug-in program 402 intended for use with a network monitoring component, such as network monitoring application 400, in FIG. 4. A determination is made whether a thread can be terminated automatically (step 600). If yes, then the thread is automatically terminated (step 602). If not, then a notification is sent a server that a thread should be terminated (step 604). The notification is presented to the user (step 606). Subsequently, the server waits for user input to terminate the thread (step 608), which may be considered manual termination.

Whether automatic or manual, the thread may be terminated by one or more methods. For example, plug-in program 402 or monitoring application 400 may direct the application program interface of the computer's operating system to terminate the thread. Plug-in program 402 may terminate the thread directly. In addition, additional byte code at the program level could be used to interact with plug-in program 402. The additional byte code detects a notification from plug-in program 402 and reacts by skipping a new thread (preventing a new thread from running) or by throwing an exception to interrupt the current thread. In a deadlock scenario, for example, a mutex could be notified that the current thread is blocked. Subsequently inserted byte code could then interact with monitoring application 400 to terminate the current thread.

The inventions described herein provide for a method of automatically terminating a thread within a program, without terminating the program, when a parameter associated with the program violates a threshold. Thus, the inventions described herein solve the computer resource problem that occurs when a thread consumes too much of a computer's resources or when a thread consumes too much time.

In addition, plug-in program 402 can monitor a parameter associated with a number of transactions within a connection. Here, the connection corresponds to application 400 and each transaction corresponds to a thread 404. If the parameter of a transaction violates a threshold, then plug-in program 402 or monitoring application 400 causes the transaction to be terminated without terminating the connection.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for monitoring a set of threads monitored by a monitoring process, the method comprising:
establishing communications with components used by the monitoring process;
monitoring a thread in the set of threads through the communications to determine whether a parameter corresponding to the thread violates a threshold; and
selectively interrupting the thread within the set of threads if the parameter violates the threshold, wherein other threads in the set of threads continue execution.

2. The method of claim 1 wherein the step of selectively interrupting the thread comprises not interrupting the thread if interrupting the thread would interfere with execution of at least one of the other threads in the set of threads.

3. The method of claim 1, wherein the monitoring process is performed by a monitoring program.

4. The method of claim 3, wherein the establishing step, the monitoring step, and the selectively interrupting step are performed by a plug-in program operably coupled to the monitoring program.

5. The method of claim 1 wherein:
the data processing system has an amount of resources allocated to the set of threads;
the parameter is the percentage of the allocated resources used by the thread; and
the threshold is a second percentage of the allocated amount of resources.

6. The method of claim 1 wherein:
the parameter associated with the thread is a time required for the thread to complete a transaction; and
the threshold comprises a maximum allotted time for the thread to complete the transaction.

7. A method of managing a first program running on a computer, said first program having a set of threads, wherein a respective parameter is associated with each thread within the set of threads, and wherein a second program is operably coupled to the first program, said method comprising the steps of:
monitoring each thread with the second program for whether the respective parameter violates a threshold; and
selectively interrupting a corresponding individual thread within the set of threads if the respective parameter violates the threshold;
wherein the step of interrupting the corresponding individual thread allows other threads within the set of threads to continue execution.

8. The method of claim 7 wherein:
the computer has an amount of resources allocated to the program;
the parameter is the percentage of the allocated resources used by each respective thread within the set of threads; and
the threshold is a second percentage of the allocated amount of resources.

9. The method of claim 7 wherein:
the parameter associated with each thread within the set of threads is a time required for a thread to complete a transaction; and
the threshold comprises a maximum allotted time for a respective thread to complete the transaction.

10. The method of claim 7 wherein the method further manages a third program running on the computer, said third program having a second set of threads, wherein a respective second parameter is associated with each thread within the second set of threads, and wherein the second program is operably coupled to the third program, said method comprising the steps of:
monitoring each thread within the second set of threads with the second program for whether the respective second parameter violates a second threshold; and
selectively interrupting an individual thread within the second set of threads if the respective second parameter violates the second threshold;
wherein the step of interrupting the individual thread allows other threads within the second set of threads to continue execution.

11. The method of claim 10 wherein:
the computer has an amount of resources allocated to the third program;
the second parameter is the respective percentage of the allocated resources used by each thread of the second set of threads; and
the second threshold is a second percentage of the allocated amount of resources.

12. The method of claim 10 wherein:
the parameter associated with each thread within the second set of threads is a time required for a thread within the second set of threads to complete a transaction; and
the second threshold comprises a maximum allotted time for a thread within the second set of threads to complete the transaction.

13. A computer program product in a computer readable medium for managing a second program running on a computer, wherein the second program has a set of threads and wherein a respective parameter is associated with each thread within the set of threads, wherein said computer program product comprises:
first instructions for monitoring each thread within the second program for whether the respective parameter violates a threshold;
second instructions for selectively interrupting a corresponding individual thread within the set of threads if the respective parameter violates the threshold; and
third instructions for ensuring that the act of interrupting the corresponding thread allows other threads within the set of threads to continue execution.

14. The computer program product of claim 13 wherein:
the computer has an amount of resources allocated to the second program;
the parameter is the respective percentage of the allocated resources used by each thread; and
the threshold is a second percentage of the allocated amount of resources.

15. The computer program product of claim 13 wherein:
the parameter associated with each thread within the set of threads is a time required for a respective thread to complete a transaction; and
the threshold comprises a maximum allotted time for a respective thread to complete the transaction.

16. A data processing system for managing a first program running on the data processing system, wherein the first program has a set of threads and a respective parameter is associated with each thread within the set of threads, and wherein a second program operably coupled to the first program is also running on the data processing system, said data processing system comprising:
means for carrying out first instructions for monitoring, using the second program, each thread within the first set of threads for whether the respective parameter violates a threshold, wherein said means contains the first instructions;
means for carrying out second instructions for selectively interrupting a corresponding individual thread within the set of threads if the respective parameter violates the threshold, wherein said means contains the second instructions; and
means for carrying out third instructions for ensuring that the act of interrupting the corresponding individual thread allows other threads within the set of threads to continue execution, wherein said means contains the third instructions.

17. The data processing system of claim 16 wherein:
the data processing system has an amount of resources allocated to the first program;
the parameter is the respective percentage of the allocated resources used by each thread; and
the threshold is a second percentage of the allocated amount of resources.

18. The data processing system of claim 16 wherein:
the parameter associated with each thread within the set of threads is a time required for a respective thread to complete a transaction; and
the threshold comprises a maximum allotted time for a respective thread to complete the transaction.

19. A data processing system comprising:
a bus;
a memory operably connected to the bus;
a processor unit operably connected to the bus;
a computer program product in the memory for managing a second program running on a computer, wherein the second program has a set of threads and wherein a respective parameter is associated with each thread, said computer program product comprising:
first instructions for monitoring each thread for whether the respective parameter associated with a corresponding thread violates a threshold;
second instructions for selectively interrupting a corresponding thread within the set of threads if the respective parameter violates the threshold; and
third instructions for ensuring that the act of interrupting the corresponding thread allows other threads within the set of threads to continue execution.

20. The data processing system of claim 19 wherein:
the data processing system has an amount of resources allocated to the first program;
the parameter is the respective percentage of the allocated resources used by each thread; and
the threshold is a second percentage of the allocated amount of resources.

21. The data processing system of claim 19 wherein:
the parameter associated with each thread within the set of threads is a time required for a respective thread to complete a transaction; and
the threshold comprises a maximum allotted time for a respective thread to complete the transaction.
